(19) United States
(12) Patent Application Publication
(10) Pub. No.: US 2014/0032728 A1
(43) Pub. Date: Jan. 30, 2014

(54) LOCATION-BASED TASK ACTIVATION

(71) Applicants: JOHN CONOR O'NEIL, Boise, ID (US); Nathan Alan McIntyre, Meridian, ID (US)

(72) Inventors: JOHN CONOR O'NEIL, Boise, ID (US); Nathan Alan McIntyre, Meridian, ID (US)

(21) Appl. No.: 13/561,565

(22) Filed: Jul. 30, 2012

(51) Int. Cl. G06F 15/173

(52) U.S. Cl. 709/223

(57) ABSTRACT

A system includes a network device to process a request to perform a task, wherein the request specifies location data for an entity generating the request. A distance manager, corresponding to instructions executable by a processor, can determine an activation time for the task by the network device based on the location data.

### BACKGROUND

Technology has provided many opportunities for increased productivity gains but also with resultant power savings depending upon the application. For example, many computers go into “sleep mode” when there is no activity detected for a predetermined amount of time. Such modes not only conserve power but also can extend the life of the underlying computer hardware. When the user reengages the computer, the computer can be restarted with some delay while the display and/or other software functions (e.g., drivers) are powered on. In another example, devices such as printers and copiers often go into power savings mode during periods of inactivity.

### BRIEF DESCRIPTION OF THE DRAWINGS

FIG. 1 illustrates an example of a system that facilitates location-based task activation.

FIG. 2 illustrates an example of a system that employs static or dynamic location-based data to process a distance time variable for task activation.

FIG. 3 illustrates an example method for location-based task activation.

FIG. 4 illustrates an example method for location-based task activation based on a static specification for location-based data.

FIG. 5 illustrates an example method for location-based task activation based on a dynamic specification for location-based data.

FIG. 6 illustrates an example system that employs a processor executing instructions in a memory for location-based task activation.

### DETAILED DESCRIPTION

Systems and methods are provided that facilitate location-based task activation to maximize power conservation and mitigate time waiting for power conservation modes to be deactivated before completing the task. A requesting device for a task submits a task request to a network device to fulfill the task, wherein the network device can be in a power-savings mode before receiving the task request. The task request includes some indication of the location of the requesting device. Based on estimates of the distance that the requesting device is from the network device, the network device can determine when to begin a task in order that the task can be fulfilled on time and without causing unnecessary delay waiting for the network device to come out of power-savings mode. Thus, in one specific example, a printer (or other device) can remain in power savings mode until a task request for a printing is made. The task request can include location-based data and other parameters that enable the printer to determine when to come out of power savings mode and when to complete the task of printing before an entity arrives to collect the respective prints. Thus, not only can power savings be maximized by waiting as long as possible to come out of power-savings mode, but efficiency can also be increased by mitigating the amount of time an entity such as a user or device making the request need to wait while the network device comes out of power-savings mode to fulfill the request.

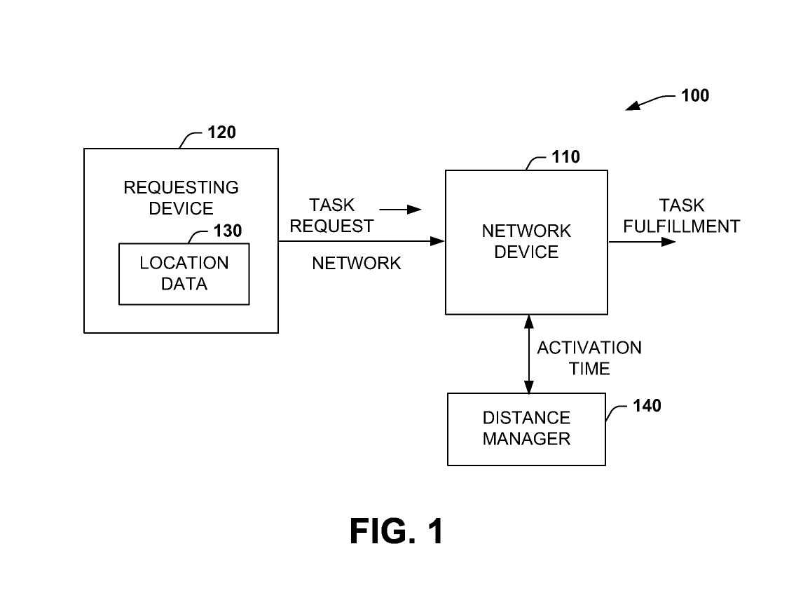

FIG. 1 illustrates an example of a system 100 that facilitates location-based task activation. The system 100 includes a network device 110 to process a request by a requesting device 120 to perform a task, wherein the request specifies location data 130 for an entity generating the request. Such entity could be a user in some examples operating the requesting device 120 and making the request to perform some task such as printing or copying, for example. In another example, the request could be made by an entity operating the requesting device 120 such as a robot, for example, requesting that some task be performed by the network device 110. A distance manager 140 can determine an activation time for the task by the network device 110 based on the location data 130, wherein the activation time can include the time to complete the task.

The distance manager 140 can be a third party component that communicates with the network device 110 or can be integrated within the network device, for example. The network device 110 can perform the task or can submit an activation message to a task fulfillment component (not shown) to perform the task. For example, the network device 110 could be a central processor for task requests and performs the task of computing when tasks should be activated in view of the location data 130 and in order to fulfill the requests in a timely manner while conserving power. Upon such determination, the network device 110 could submit a request to the task fulfillment component (e.g., printer or copier in power-savings mode) to complete the request. In other examples, the network device 110, determines the activation time in accordance with computations from the distance manger 140 and also acts as the task fulfillment component.

In one example, the distance manager 140 computes a distance time variable to complete the task based on the location data 130. The distance manager 140 can compute the distance time variable utilizing a time estimate for the network device to become ready to begin the task, a time estimate based on task specifications, or an estimated distance based on a point of origin of the request, for example. The distance manager 140 can determine the estimated distance based on a static parameter specified in the request and/or a dynamic parameter based on coordinates that are generated by the requesting device 120 that generates the request. The dynamic parameter can be updated over the course of time to cause the distance time variable to be recomputed. The dynamic parameter or the static parameter can be updated from data generated from a geo-positioning system (GPS), a radio frequency identification (RFID) tag, a user specification, a device parameter, a network address, a task parameter, and/or a biological detection system, for example. In yet another example, the distance specified with the request could be for some other party who would be receiving the fulfillment results from the request. For example, one person might make a request for a print job and specify that coordinates for distance be obtained from some other person (or entity) that will be arriving to pick up the job. The person making the request could also specify the coordinates for the other entity receiving the results rather than direct the system to obtain alternative coordinates from the other entity.

The network device 110 can be a printer, a copier, a fax machine, an appliance, a vehicle, a computer, a wireless control device, a task fulfillment component, or an environmental control system, for example. For example, the task request could be a message indicating the user's current location with the message triggering some type of appliance activation (e.g., air conditioner) based on the user's current location (e.g., distance 1 hour from home, start appliance in ½ hour to fulfill cooling request in timely manner while conserving maximal energy). Also, a policy (or policies) can be specified that controls how the distance manager 140 determines the activation time for the task. For example, one policy may specify that for network devices that are not too far away from the origin of the request, that activation times should be minimized (e.g., less than a predetermined amount of time for print jobs located in my office). In another policy example, additional time may be added to the activation time to account for nuances in travel (e.g., add additional activation time to account for walking up four flights of stairs to printing room). Policies can be specified for various reasons to alter how the distance manager 140 determines the activation time and/or how long it takes for the network device 110 to perform task fulfillment.

In one specific example for network devices 110, printers can go into and come out of power savings mode (sleep) based on the following criteria such as job submission, network resource access, physical interactions with the device (hard-keys, touch screen, trays, and so forth), and scheduled timeouts. The system 100 facilitates efficient operations for a user with a network enabled device 120 (e.g., a smart phone, tablet, or laptop) that can signal a network device 110 wake-up procedure based on geo-location data or other location data 130. Such device wake-up processes can be employed to control the amount of power required by the network device 110, as well as required time to complete a task (e.g., print) based on said users (or device) location. Thus, the system 100 facilitates conserving energy while promoting maximum uptime for the network device 110 at a usable state. By calculating geo-location enabled device wakeup procedures by the distance manager 140, the system 100 allows for maximum device “sleep time” which reduces the amount of power required by the device over time leading to a reduction in cost to operate. This can also result in improved user experience by facilitating that the user is notified when their print job can be completed as well as detecting when it needs to start each print job based on the user's location. This is also advantageous in situations where there are a large number of users accessing the same network device 110 (e.g., printer) at various times of the day from varying geo-location distances.

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component.

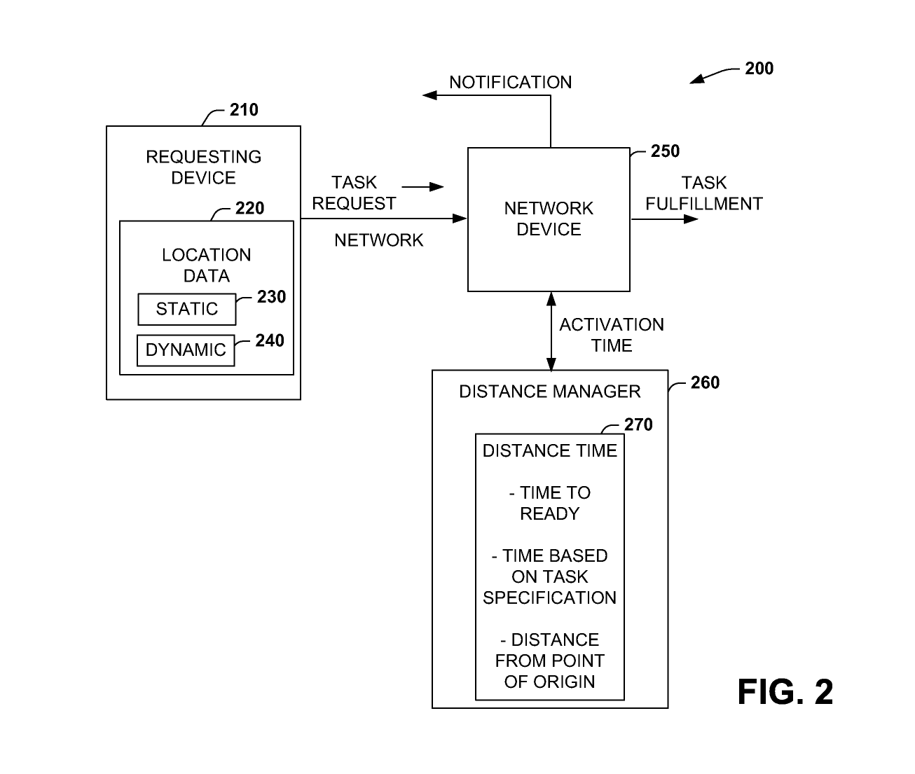

FIG. 2 illustrates an example of a system 200 that employs static or dynamic location-based data 210 to process a distance time variable for task activation. As shown, a requesting device 210 generates a task request based on location data 220 that can include static data 230 or dynamic data 240. Static data 230 can be generated via any of the methods previous described such as GPS data but is typically specified one time without further updates in entity location. Dynamic data 240 can be updated over the course of time (e.g., periodically updated over the course of a day and periodically re-submitted to network device. A network device 250 receives the task request along with the location data 220, wherein a distance manager 260 computes an activation time for task fulfillment based on a distance time variable 270. Upon determining when the task can be fulfilled, the network device 250 can send a notification (e.g., electronic message) back to the requesting device 210.

In one specific example, the system 200 enables network devices 250 such as printers to dynamically calculate the amount of time required to wake-up to a fully capable ready state depending on the user's (or entity) location. Each print task can be assigned a point of origin address based on the location data 220 that can be sent along with the task request in addition to task information such as total number of pages, colors, impositions, and so forth. After the network device 250 receives this information, it can then calculate the time required not only for wake-up but also to print the job and then process it according to a pre-determined user configuration such as can be achieved via the policies described above.

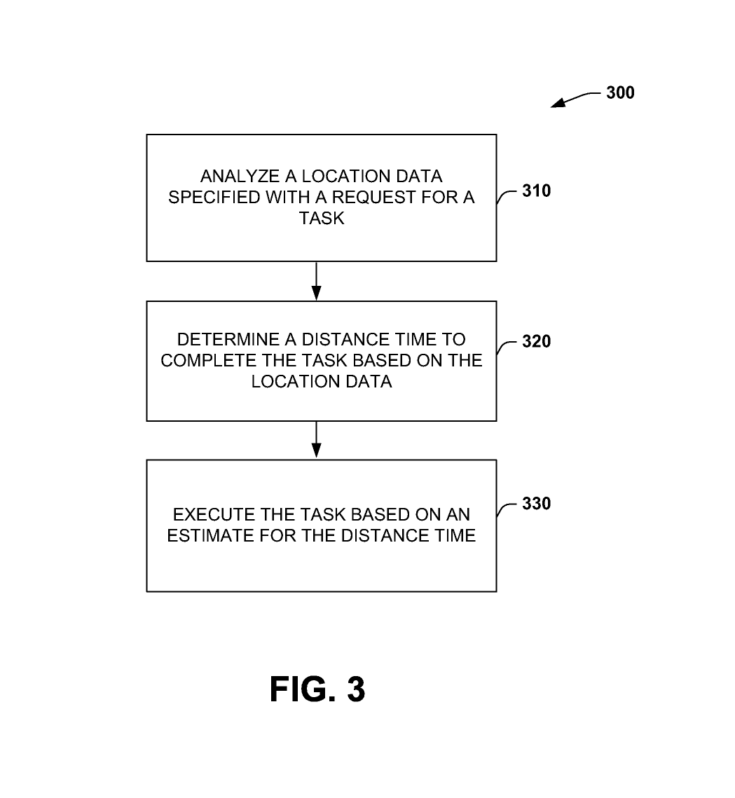

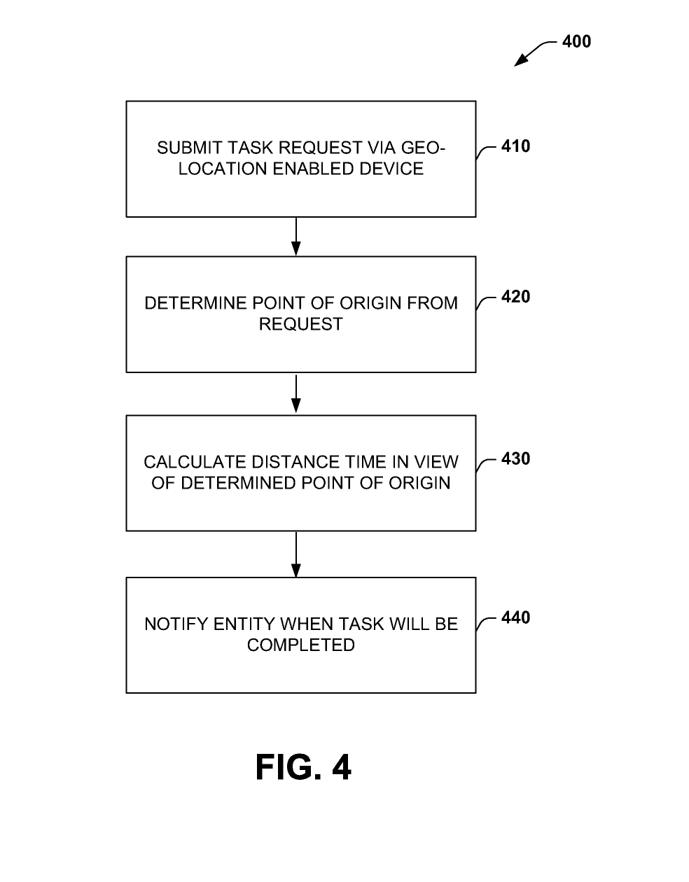

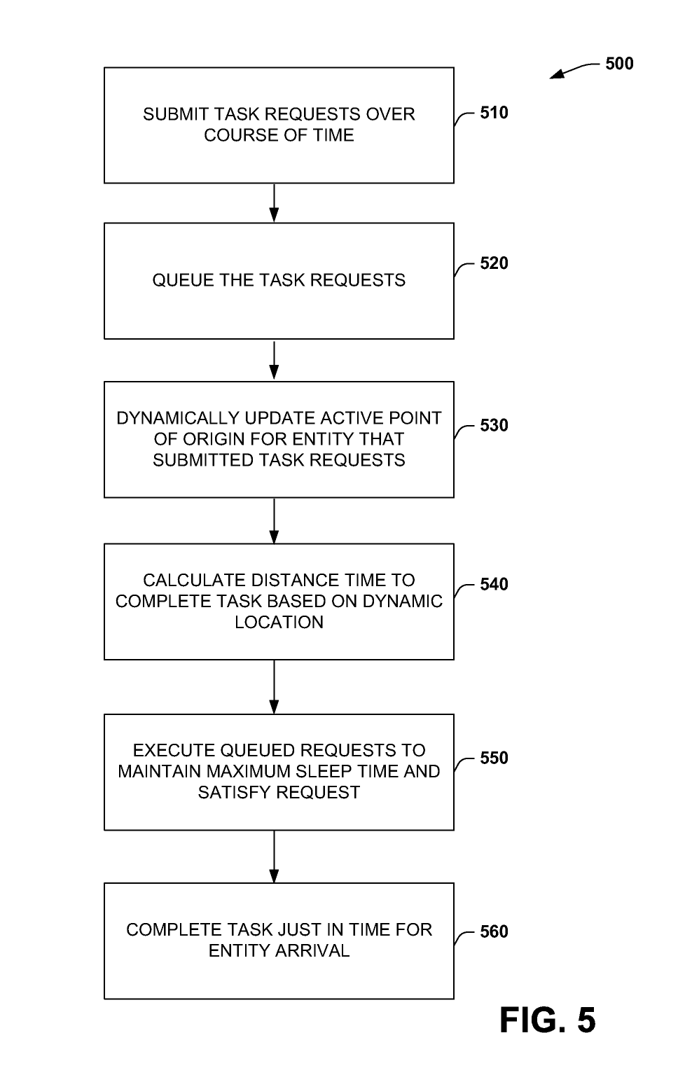

The printer (or network device) can calculate the required time to process each job submission which can be based on the following criteria specified as a distance time variable 270 (e.g., distance time to print). The distance time variable can include a device specification for “time to ready” that include time required to start up all device components to a read state (e.g., for printing). Another aspect for the distance time variable 270 can include the general amount of time (e.g., print time) required based on job specifications, device specifications (e.g., page size, print engine speed, and so forth). Another aspect of the distance time 270 can include distance from a point of origin address and the network device (e.g., print device). This can be a static value 230 or a dynamic value 240 based on user preference and the ability to live stream the coordinates (e.g., via GPS) of the user/device. FIGS. 3-5 below will further describe methods for location-based task activation (FIG. 3), location-based task activation utilizing static specifications (FIG. 4), and location-based task activation utilizing dynamic specifications (FIG. 5).

In view of the foregoing structural and functional features described above, example methods will be better appreciated with reference to FIGS. 3-5. While, for purposes of simplicity of explanation, the example methods of FIGS. 3-5 are shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method. The example methods of FIGS. 3-5 can be implemented as machine-readable instructions that can be stored in a non-transitory computer readable medium, such as can be computer program product or other form of memory storage. The computer readable instructions corresponding to the methods of FIGS. 3-5 can also be accessed from memory and be executed by a processor.

FIG. 3 illustrates a method 300 for location-based task activation. At 310, the method 300 includes analyzing location data specified with a request for a task (e.g., via network device 110 of FIG. 1). At 320, the method 300 includes determining a distance time to complete the task based on the location data (e.g., via distance manager 140 of FIG. 1). At 330, the method 300 includes executing the task based on an estimate for the distance time (e.g., via distance manager 140 and network manager 110 of FIG. 1). As will be described below with respect to FIGS. 4 and 5, static or dynamic location data can be utilized to specify the location data. Moreover, determining the distance time of the method 300 can include computing a time estimate for a device to become ready to begin the task, computing a time estimate based on task specifications, and/or computing an estimated distance based on a point of origin of the request.

The method 300 can be executed by a network device to process a request to perform a task, wherein the request specifies location data for an entity generating the request. The network device can include a distance manager, corresponding to instructions executable by a processor, to determine a distance time variable to execute the task by the network device. The distance time variable can include a time estimate for a device to become ready to begin the task, a time estimate based on task specifications, and an estimated distance based on the location data specified. The network device can process the location data as a static parameter in the request or can process the location data as a dynamic parameter in the request that is periodically updated over the course of time.

FIG. 4 illustrates an example method 400 for location-based task activation based on a static specification for location-based data. At 410 of the method 400, an entity such as a user submits a task request from a geo-location enabled device (e.g., submit print request from wireless tablet computer). At 420, the method 400 includes determining a point of origin from the request (e.g., via network device of FIG. 1). Such point of origin could be determined from GPS coordinates generated by a requesting device, an address associated with the request, from RFID parameters, from a user specification, from biological detection (e.g., hall sensors detecting user's presence, and so forth). At 430, of the method 400, calculate a distance time to complete the task based on the determined point of origin. As noted previously, distance time can include how far away the user is from getting the results of the task and thus affecting when the network device has to begin the task. Other aspects of distance time computations include the time it takes to come out of power-down mode and the time it takes to execute the requested task at hand (e.g., number of pages to print). At 440 of the method 400, notify the entity generating the request that the task has been completed (or will be completed). Such notification can occur via the network device of FIG. 1, for example.

FIG. 5 illustrates an example method 500 for location-based task activation based on a dynamic specification for location-based data. In contrast to the method 400 described above that executes a task based on an initial specification of location-based data, the method 500 includes executing a task based on dynamic specifications of location-based data that can be updated over the course of time. At 510 of the method 500, submit task requests over the course of time. For example, a user employing a GPS-enabled device could submit various task requests over the course of the day (e.g., via requesting device of FIG. 1, submit a plurality of print requests). At 520, the method 500 queues the task requests (e.g., queue each request in a memory of network device of FIG. 1).

At 530 of the method 500, dynamically update active point of origin for the entity that submitted the task requests (e.g., continuously update distance variable based on dynamic location data received from requesting device of FIG. 1). At 530 of the method 500, calculate a distance time to complete the overall task from the various task requests collected over time and based on the dynamic location data received at 530. At 550, execute the queued requests based on achieving the maximum sleep time for the network device and also completing the submitted task requests before arrival of the entity generating the requests. At 560, complete the task just in time for the entity to arrive that generated the request. In one example, a user operating a network device may submit various print requests over the course of the day. The user's location can be dynamically tracked via GPS coordinates (or other location data described above), wherein the various print requests can be fulfilled and timed to provide both maximum sleep time for the printer fulfilling the requests and mitigating the time that the user may have to wait for the printer to warm-up from power-conserving mode before acting on the requests.

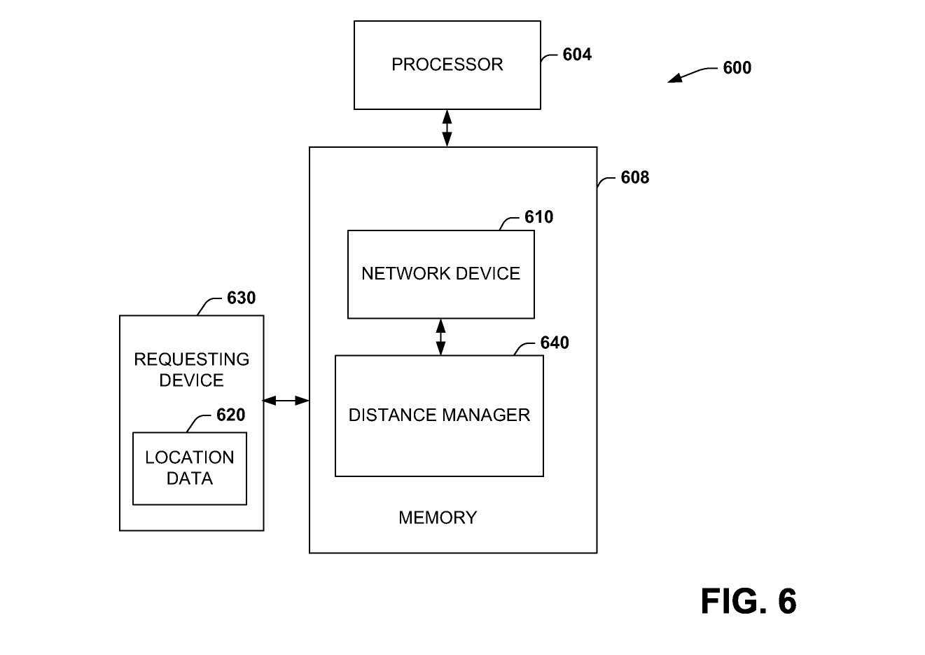

FIG. 6 illustrates an example system 600 that employs a processor executing instructions in a memory for location-based task activation. As shown, the system 600 can include a processor 604 that executes instructions in a memory 608. The memory 608 includes a network device 610 to process a request to perform a task, wherein the request specifies location data 620 for an entity such as a requesting device 630 generating the request. A distance manager 640 can determine an activation time for the task by the network device 610 based on the location data 620.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a network device to process a request to perform a task, wherein the request specifies location data for an entity generating the request; and
a distance manager, corresponding to instructions executable by a processor, to determine an activation time for the task by the network device based on the location data.

2. The system of claim 1, wherein the activation time includes the time to complete the task.

3. The system of claim 1, wherein the distance manager is a third party component that communicates with the network device or is integrated within the network device.

4. The system of claim 1, wherein the network device performs the task or submits an activation message to a task fulfillment component to perform the task.

5. The system of claim 1, wherein the distance manager computes a distance time variable to complete the task based on the location data.

6. The system of claim 5, wherein the distance manager computes the distance time variable utilizing a time estimate for the network device to become ready to begin the task, a time estimate based on task specifications, or an estimated distance based on a point of origin of the request.

7. The system of claim 6, wherein the distance manager determines the estimated distance based on a static parameter specified in the request or a dynamic parameter based on coordinates that are generated by a requesting device that generates the request.

8. The system of claim 7, wherein the dynamic parameter is updated over the course of time to cause the distance time variable to be recomputed.

9. The system of claim 7, wherein the dynamic parameter or the static parameter is updated from data generated from a geo-positioning system (GPS), a radio frequency identification (RFID) tag, a user specification, a device parameter, a network address, a task parameter, or a biological detection system.

10. The system of claim 1, wherein the network device is a printer, a copier, a fax machine, an appliance, a vehicle, a computer, a wireless control device, or an environmental control system.

11. The system of claim 1, further comprising a policy that controls how the distance manager determines the activation time for the task.

12. A method comprising:
analyzing, by a processor, location data specified with a request for a task,
determining, by the processor, a distance time to complete the task based on the location data; and
executing the task, by the processor, based on an estimate for the distance time.

13. The method of claim 12, wherein the determining the distance time includes computing a time estimate for a device to become ready to begin the task, computing a time estimate based on task specifications, or computing an estimated distance based on a point of origin of the request.

14. A non-transitory machine-readable medium comprising instructions, which when executed, cause a processor to:
process a request to perform a task, wherein the request specifies location data for an entity generating the request; and
determine a distance time variable to execute the task by the network device, wherein the distance time variable includes a time estimate for a device to become ready to begin the task, a time estimate based on task specifications, and an estimated distance based on the location data specified in the request.

15. The machine-readable medium of claim 14, wherein the instructions further cause the processor to process the location data as a static parameter in the request or process the location data as a dynamic parameter in the request that is periodically updated over the course of time.
